(19) United States
(12) Patent Application Publication
(10) Pub. No.: US 2023/0365752 A1
(43) Pub. Date: Nov. 16, 2023

(54) POLYAMIDE COMPOSITION

(71) Applicant: BOSTIK SA, Colombes (FR)

(72) Inventors: Héloïse HABRANT, VENETTE (FR); Pierre-Jean ROUMANET, COLOMBES CEDEX (FR)

(21) Appl. No.: 18/030,323

(22) PCT Filed: Oct. 6, 2021
(86) PCT No.: PCT/FR2021/051731

§ 371 Date: Apr. 5, 2023

(30) Foreign Application Priority Data
Oct. 7, 2020 (FR) 2010238

(51) Int. Cl. C08G 69/26; C08L 77/06; B29C 45/14; B29C 45/00; C09J 177/06; C09J 5/06

(52) U.S. Cl. CPC C08G 69/265; B29C 45/0001; B29C 45/14639; C08L 77/06; C09J 5/06; C09J 177/06; B29K 2077/00

(57) ABSTRACT

The present invention relates to a polyamide, to a composition comprising same, and to the use thereof, and also to a molded article deriving therefrom and to a process for producing same. The polyamide is particularly suitable as hot-melt adhesive for the low-pressure and low-temperature overmolding of a heat-sensitive battery, for example a lithium-polymer battery.

### FIELD OF THE INVENTION

The present invention relates to a polyamide, to a composition comprising same, and to the use thereof, and also to a molded article deriving therefrom and to a process for producing same. The polyamide is particularly suitable as hot-melt adhesive for the low-pressure and low-temperature overmolding of a heat-sensitive battery, for example a lithium-polymer battery.

### TECHNICAL BACKGROUND

Numerous portable electronic devices are equipped with batteries, allowing them to be used without having to be connected to the electricity supply network. In order to confer sufficient strength on them, to protect them from the environmental conditions and to prevent inappropriate handling by the user, the batteries are generally packaged in a protective casing. Generally, the casings of the batteries can be formed by overmolding starting from plastics, for example starting from polyamides, injected at low pressure. Although batteries exhibiting a satisfactory performance are already available, for example lithium-ion batteries, new technical (battery life, performance, weight, and the like), industrial (starting materials, and the like) and/or regulatory (interoperability, recyclability, and the like) constraints require the development of alternative technologies, such as lithium-polymer batteries.

Lithium-polymer batteries (or lithium ion-polymer batteries) — also denoted LiPo, LIP, Li-poly, lithium-poly — are rechargeable batteries using a polymer electrolyte instead of a liquid electrolyte. These batteries are advantageous in that they can be replaced, without destroying or damaging the electronic devices containing them. This makes it possible to increase the lifetime of the electronic devices. In addition, this makes possible the recycling of the battery, when the electronic devices containing them have broken down. Finally, these batteries exhibit a satisfactory performance. On the other hand, these batteries have the disadvantage of being sensitive to temperature and pressure. The conventional processes for low-pressure overmolding used for example for lithium-ion batteries are not suitable, in that they use plastics, for example polyamides, which have to be injected at high temperatures, generally of greater than 200° C.

Overmolding processes and/or different types of polyamides are well known. For example, application EP 1533331 A1 relates in particular to a polyamide which is the polycondensation product of an acid component comprising at least one dimerized unsaturated C₁₂-C₂₄ fatty acid, and at least one aliphatic

C₆-C₁₈ dicarboxylic acid; and an amine component comprising at least one C₂-C₈ alkylenediamine, at least one C₂₄-C₄₈ amide dimer and at least one polyoxyalkylenediamine.

Patent EP 2094802 B1 relates in particular to a molded element to be bonded to metal or synthetic-material substrates as a fixing device comprising a hot-melt adhesive, and also the use of a polyamide-based hot-melt adhesive for the production of the molded elements, the polyamide comprising from 20 to 50 mol% of a dimer fatty acid and/or of C₄-C₁₈ dicarboxylic acids, from 0 to 5 mol% of C₁₂-C₂₂ fatty acid monomers, from 5 to 50 mol% of aliphatic polyamines, from 0 to 40 mol% of cycloaliphatic diamines and from 0 to 35 mol% of polyetherdiamines, said hot-melt adhesive having a softening temperature which amounts to between 150° C. and 250° C. and a tensioning force of 1 to 35 Mpa.s.

Patent EP 2298830 B1 relates in particular to the use of a polyamide based on reaction products of at least one dimer fatty acid, of at least one aliphatic C₆-C₂₄ dicarboxylic acid and of aliphatic diamines, cycloaliphatic diamines and/or polyetherdiamines, the amounts of the amine component being chosen such that it is mainly amine groups which are contained in at the end position and the polyamide having an amine number of 2 to 20 mg of KOH/g, for the production of molded parts in low-pressure injection molding processes.

Application CN 108148198 A relates in particular to a hot-melt polyamide adhesive, which can be low-pressure injection molded, comprising a polyamide obtained by reacting from 80 to 100 mol% of at least one C₁₄-C₁₈ dicarboxylic acid, from 10 to 90 mol% of at least one C₂-C₂₀ aliphatic amine, from 10 to 80 mol% of a cycloaliphatic amine, and a from 0 to 80 mol% of at least one polyetheramine, the polyamide being free of fatty acid dimers and the sum of the diamines being 100 mol%.

Application CN 109705797 A relates in particular to an injection molding material of the polyamide type for the packaging of batteries, comprising 50 mol% of a component A and 50 mol% of a component B; component A comprising from 80 to 95 mol% of an aliphatic fatty acid dimer, from 5 to 20% of an aliphatic dicarboxylic acid; component B comprising from 70 to 90 mol% diamines, from 10 to 30% of polyetheramines; and from 5 to 20% by weight of a rosin-type resin.

Application WO 2017/007648 A1 relates to a transparent polyamide, which is the reaction product of a dimer of hydrogenated fatty acids, of a saturated linear C₆-C₁₄ carboxylic acid, of an aliphatic C₄-C₈ diamine and of a dipiperidine.

Patent EP 2311118 B1 relates in particular to a process for producing a battery, with which a cell package, consisting of at least one individual cell in a cell casing and an electronic component, which essentially consists of a cured plastic part in which are integrated and coated an electronic safety circuit and external contact surfaces of the battery in such a way that they are a constituent element of one and the same component, and during the one-step production of the battery, can be mounted and arranged in an injection molding mold and the remaining free space filled with a mass of liquid plastic which is then cured.

However, there exists a real need to provide polyamides which can be used in hot-melt adhesives and which are suitable for low-pressure and low-temperature injection molding processes. In particular, there exists the need to provide polyamides suitable for processes for the overmolding of heat-sensitive elements, in particular lithium-polymer batteries. There exists in particular the need to provide polyamides which can be injected and molded at lower temperatures than conventional overmolding processes, while retaining satisfactory mechanical and thermal properties. There also exists the need to provide polyamides which, after having been injected and molded over heat-sensitive devices, can be easily recycled.

### SUMMARY OF THE INVENTION

The invention relates in the first place to a polyamide which is the product of the polycondensation of an acid component and of an amine component,
the acid component comprising, per mole of acid component:
   from 25 to 50 mol%, preferentially from 30 to 50 mol%, very preferentially from 35 to 50 mol%, of at least one fatty acid dimer;
   from 46 to 70 mol%, preferentially 49 to 70 mol%, very preferentially from 52 to 70 mol%, of at least one aliphatic diacid;
   from 0 to 11 mol%, preferentially 0 to 10 mol%, very preferentially from 2 to 5 mol%, of at least one chain limiter;
the amine component comprising, per mole of amine component:
   from 13 to 29 mol%, preferentially 16 to 26 mol%, very preferentially from 19 to 23 mol%, of at least one aliphatic diamine;
   from 66 to 82 mol%, preferentially 69 to 79 mol%, very preferentially from 72 to 76 mol%, of at least one cycloaliphatic diamine; and
   from 0 to 15 mol%, preferentially 0 to 10 mol%, very preferentially from 3 to 5 mol%, of at least one polyetheramine;
the polyamide comprising a —COOH/(—NH and/or —NH₂) molar ratio of from 1.00 to 1.20, preferentially from 1.04 to 1.15, very preferentially from 1.07 to 1.11.

In embodiments, the fatty acid dimer is the product of the reaction for coupling unsaturated monocarboxylic acids; preferentially unsaturated monocarboxylic acids chosen from unsaturated monocarboxylic acids comprising from 10 to 22 carbon atoms; very preferentially from unsaturated monocarboxylic acids comprising from 12 to 18 carbon atoms; more preferentially from unsaturated monocarboxylic acids comprising from 16 to 18 carbon atoms.

In embodiments, the aliphatic diacid is chosen from saturated aliphatic dicarboxylic acids; preferentially from linear or branched, saturated aliphatic dicarboxylic acids; very preferentially from linear saturated dicarboxylic acids having from 4 to 22 carbon atoms; more preferentially from succinic acid, glutaric acid, adipic acid, pimelic acid, suberic acid, azelaic acid, sebacic acid, undecanedioic acid, dodecanedioic acid, brassylic acid, tetradecanedioic acid, pentadecanedioic acid, thapsic acid, and mixtures thereof; even more preferentially from azelaic acid, sebacic acid, dodecanedioic acid and mixtures thereof.

In embodiments, the chain limiter is chosen from monocarboxylic acids, anhydrides, monohalogenated acids, monoesters or monoisocyanates; preferentially, the chain limiter is a monocarboxylic acid; very preferentially, the chain limiter is chosen from aliphatic monocarboxylic acids, alicyclic acids, aromatic monocarboxylic acids and mixtures thereof; more preferentially, the chain limiter is an aliphatic monocarboxylic acid.

In embodiments, the aliphatic diamine is chosen from linear or branched, saturated aliphatic diamines; preferentially from saturated linear aliphatic diamines of formula H₂N—(CH₂)ₙ—NH₂ with n between 2 and 12; very preferentially from ethylenediamine, propanediamine, butanediamine, pentanediamine, hexanediamine, decanediamine and mixtures thereof; more preferentially, the aliphatic diamine is ethylenediamine.

In embodiments, the cycloaliphatic diamine is chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), bis(p-aminocyclohexyl)methane (PACM), isopropylidenedi(cyclohexylamine) (PACP), isophoronediamine, piperazine, aminoethylpiperazine, dimethylpiperazine, 4,4′-trimethylenedipiperidine, 1,4-cyclohexanediamine, a cycloaliphatic diamine having a carbon-based backbone (for example norbornylmethane, cyclohexylmethane, dicyclohexylpropane, di(methylcyclohexyl), di(methylcyclohexyl)propane) and mixtures thereof; preferentially, the cycloaliphatic diamine is piperazine.

In some embodiments, the polyetheramine is chosen from polyoxyalkylenediamines with a number-average molecular weight (Mn) ranging from 200 to 4000 g/mol; preferentially, the polyetheramine is chosen from polyoxypropylenediamines, polyoxybutylenediamines, bis(diaminopropyl)polytetrahydrofuran and mixtures thereof; very preferentially, the polyetheramine is polyoxypropylenediamine.

In embodiments, the polyamide is the product of the polycondensation of an acid component and of an amine component,
the acid component comprising, per mole of acid component:
   from 35 to 50 mol% of at least one fatty acid dimer;
   from 52 to 70 mol% of at least one aliphatic diacid;
   from 2 to 5 mol% of at least one chain limiter;
the amine component comprising, per mole of amine component:
   from 19 to 23 mol% of at least one aliphatic diamine which is ethylenediamine;
   from 72 to 76 mol% of at least one cycloaliphatic diamine which is piperazine; and
   from 3 to 5 mol% of at least one polyetheramine which is polyoxypropylenediamine;
the polyamide comprising a —COOH/(—NH and/or —NH₂) molar ratio of from 1.07 to 1.11.

The invention relates in the second place to a composition comprising the polyamide as defined previously.

In embodiments, the composition comprises at least one additive; preferentially at least one additive chosen from fillers, antioxidants or stabilizers, mold-release agents, adhesion promoters, pigments and mixtures thereof.

In embodiments, the polyamide has a viscosity of 10,000 mPa.s or less; preferentially from 3000 to 6000 mPa.s, at a temperature of 150° C.

In embodiments, the polyamide composition has a softening point of 150° C. or less; preferentially from 100 to 145° C.; very preferentially from 115 to 140° C.

The invention relates in the third place to a molded article comprising an insert, preferentially a lithium-polymer battery, and the polyamide composition as defined previously, said insert being overmolded at least in part by the polyamide composition

The invention relates in the fourth place to a process for producing a molded article, comprising the following steps:
providing a mold;
inserting an insert into the mold, preferentially a lithium-polymer battery;
heating the polyamide composition to a temperature of 150° C. or less, preferentially from 120° C. to 150° C., in order to obtain a molten polyamide composition;
injecting the molten polyamide composition at a pressure of from 0.5 × 10⁵ to 50×10⁵ Pa, preferentially from 2 × 10⁵ to 40 × 10⁵ Pa;
cooling the injected polyamide composition;
optionally removing the obtained molded article from the mold.

The invention relates in the fifth place to the use of the polyamide or of the composition comprising same, as defined previously, as a hot-melt adhesive for the low-pressure overmolding of a heat-sensitive battery.

The present invention makes it possible to meet the needs expressed above. Surprisingly, the inventors have demonstrated that the polyamide according to the present invention is particularly suitable for the production of casings for batteries, in particular for lithium-polymer batteries. This is because the polyamide, or the composition comprising same, can be injected at low pressure and at low temperature, in particular at a temperature of 150° C. or less, which is particularly suitable for the overmolding of heat-sensitive elements, in particular heat-sensitive batteries. In addition, although the viscosity and the softening point of the polyamide are lower than the viscosities and than the softening points of known polyamides used in processes for the overmolding of batteries, the casing thus obtained by overmolding exhibits satisfactory mechanical and thermal properties, in particular a satisfactory impact strength, at high temperature gradients in use (for example as a function of the seasons and of the electronic device heating). Finally, the adhesion of the injected and molded polyamide to different types of substrate (for example an acrylonitrile-butadiene-styrene or ABS substrate) is satisfactory.

### DETAILED DESCRIPTION

The invention is now described in more detail and in a non-limiting way in the description which follows.

For the purposes of the present invention, the term “hot-melt” is intended to mean the ability of the polyamide to melt under the effect of heat.

In the description, unless otherwise indicated, all the percentages indicated are molar percentages.

For the purposes of the present invention, the expression “between... and...” or “from... to...” is intended to mean that the limits are included in the range described.

### Polyamide

In a first aspect, the present invention relates to a polyamide which is the product of the polycondensation of an acid component and of an amine component,
the acid component comprising, per mole of acid component:
   from 25 to 50 mol%, preferentially from 30 to 50 mol%, very preferentially from 35 to 50 mol%, of at least one fatty acid dimer;
   from 46 to 70 mol%, preferentially 49 to 70 mol%, very preferentially from 52 to 70 mol%, of at least one aliphatic diacid;
   from 0 to 11 mol%, preferentially 0 to 10 mol%, very preferentially from 2 to 5 mol%, of at least one chain limiter;
the amine component comprising, per mole of amine component:
   from 13 to 29 mol%, preferentially 16 to 26 mol%, very preferentially from 19 to 23 mol%, of at least one aliphatic diamine;
   from 66 to 82 mol%, preferentially 69 to 79 mol%, very preferentially from 72 to 76 mol%, of at least one cycloaliphatic diamine; and
   from 0 to 15 mol%, preferentially 0 to 10 mol%, very preferentially from 3 to 5 mol%, of at least one polyetheramine;
the polyamide comprising a —COOH/(—NH and/or —NH₂) molar ratio of from 1.00 to 1.20, preferentially from 1.04 to 1.15, very preferentially from 1.07 to 1.11.

The —COOH/(—NH and/or —NH₂) molar ratio between the carboxylic functions and the primary and/or secondary amine functions, the contents of which are expressed in mg KOH/g, is determined by potentiometry.

The polyamide can be obtained by polycondensation of the acid component and of the amine component according to a conventional process. Depending on the process used, the polyamide may be a random polymer or a block polymer, preferentially a random polymer.

### Fatty Acid Dimers

Fatty acid dimers are polymerized fatty acids which denote compounds produced from coupling reactions of unsaturated fatty acids which result in mixtures of products bearing two acid functions. The fatty acid dimer can be obtained by a dimerization reaction of unsaturated monocarboxylic acids. The fatty acid dimer is thus the reaction product of the coupling of unsaturated monocarboxylic acids. The unsaturated monocarboxylic acids can be chosen from unsaturated monocarboxylic acids comprising from 10 to 22 carbon atoms (C₁₀ to C₂₂); preferentially from unsaturated monocarboxylic acids comprising from 12 to 18 carbon atoms (C₁₂ to C₁₈); very preferentially from unsaturated monocarboxylic acids comprising from 16 to 18 carbon atoms (C₁₆ to C₁₈).

The fatty acid dimers can be obtained, from unsaturated monocarboxylic acids, by well-known processes, such as described, for example, in patent applications US 2 793 219 and US 2 955 121. The unsaturated monocarboxylic acids can be chosen from oleic acid, linoleic acid, linolenic acid and their mixtures.

According to whether they are crude or distilled, the fatty acid dimers exhibit a content of dimers ranging from 75% to more than 98%, as a mixture with greater or lesser amounts of monomers, trimers and higher homologues, according to the commercial grade.

Fatty acid dimers are available commercially under the names Radiacid® from Oleon, Pripol® from Croda or Unydime® from Kraton.

### Aliphatic Diacids

Throughout the description, the expressions “diacid”, “carboxylic diacid” and “dicarboxylic acid” denote the same product.

The aliphatic diacid can be chosen from saturated aliphatic dicarboxylic acids; preferentially from linear or branched, saturated aliphatic dicarboxylic acids; very preferentially from among the saturated aliphatic dicarboxylic acids having from 4 to 22 carbon atoms (C₄-C₂₂); more preferentially from succinic acid (butanedioic acid) (C₄), glutaric acid (pentanedioic acid) (C₅), adipic acid (hexanedioic acid) (C₆), pimelic acid (heptanedioic acid) (C₇), suberic acid (octanedioic acid) (C₈), azelaic acid (nonanedioic acid) (C₉), sebacic acid (decanedioic acid) (C₁₀), undecanedioic acid (C₁₁), dodecanedioic acid (C₁₂), brassylic acid (tridecanedoic acid) (C₁₃), tetradecanedioic acid (C₁₄), pentadecanedioic acid (C₁₅), thapsic acid (hexadecanedioic acid) (C₁₆), and mixtures thereof; even more preferentially from azelaic acid (C₉), sebacic acid (C₁₀), dodecanedioic acid (C₁₂) and mixtures thereof.

### Chain Limiters

The polyamide according to the invention is synthesized in a conventional manner, if necessary in the presence of at least one chain limiter.

The chain limiter can be chosen from monocarboxylic acids, anhydrides (for example phthalic anhydride), monohalogenated acids, monoesters or monoisocyanates; preferentially, the chain limiter is a monocarboxylic acid; very preferentially, the chain limiter is chosen from aliphatic monocarboxylic acids, alicyclic acids, aromatic monocarboxylic acids and mixtures thereof; more preferentially, the chain limiter is an aliphatic monocarboxylic acid. The monocarboxylic acid can be an aliphatic monocarboxylic acid chosen from acetic acid, propionic acid, lactic acid, valeric acid, caproic acid, capric acid, lauric acid, tridecylic acid, myristic acid, palmitic acid, stearic acid, pivalic acid, isobutyric acid or their mixtures. The alicyclic acid can be a cyclohexanecarboxylic acid. The aromatic monocarboxylic acid can be chosen from benzoic acid, toluic acid, α-naphthalenecarboxylic acid, β-naphthalenecarboxylic acid, methylnaphthalenecarboxylic acid, phenylacetic acid and their mixtures.

Chain limiters are commercially available under the name Radiacid® from Oleon.

### Aliphatic Diamines

The aliphatic diamine can be chosen from linear or branched, saturated aliphatic diamines; preferentially from saturated linear aliphatic diamines of formula H₂N—(CH₂)ₙ—NH₂ with n between 2 and 12; very preferentially from ethylenediamine, propanediamine, butanediamine, pentanediamine, hexanediamine, decanediamine and mixtures thereof; more preferentially, the aliphatic diamine is ethylenediamine. The advantageous branched aliphatic diamines include 2-methylpentamethylenediamine, 1,3-pentanediamine, methylpentanediamine and trimethylhexamethylenediamine.

### Cycloaliphatic Diamines

The cycloaliphatic diamine can be chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), bis(p-aminocyclohexyl)methane (PACM), isopropylidenedi(cyclohexylamine) (PACP), isophoronediamine, piperazine, aminoethylpiperazine, dimethylpiperazine, 4,4′-trimethylenedipiperidine, 1,4-cyclohexanediamine, a cycloaliphatic diamine having a carbon-based backbone (for example norbornylmethane, cyclohexylmethane, dicyclohexylpropane, di(methylcyclohexyl), di(methylcyclohexyl)propane) and mixtures thereof; preferentially, the cycloaliphatic diamine is piperazine.

A non-exhaustive list of these cycloaliphatic diamines is given in the publication “Cycloaliphatic Amines” (Encyclopedia of Chemical Technology, Kirk-Othmer, 4th Edition (1992), pp. 386-405).

### Polyetheramines

The polyetheramine can be chosen from polyoxyalkylene diamines with a number-average molecular weight (Mn) ranging from 200 to 4000 g/mol. Preferably, it concerns a polyoxyalkylene chain bearing an amine group at the chain end. The polyetheramine can be chosen from polyoxypropylenediamines, polyoxybutylenediamines, bis(diaminopropyl)polytetrahydrofuran and mixtures thereof; very preferentially, the polyetheramine is polyoxypropylenediamine. Polyetheramines are available commercially under the Jeffamine® name from Huntsman and the Baxxodur® name from BASF.

In one particular embodiment, the polyamide is the product of the polycondensation of an acid component and of an amine component,
the acid component comprising, per mole of acid component:
   from 35 to 50% of at least one fatty acid dimer;
   from 52 to 70% of at least one aliphatic diacid;
   from 2 to 5% of at least one chain limiter;
the amine component comprising, per mole of amine component:
   from 19 to 23% of at least one aliphatic diamine which is ethylenediamine (C₂);
   from 72 to 76% of at least one cycloaliphatic diamine which is piperazine; and
   from 3 to 5% of at least one polyetheramine which is polyoxypropylenediamine;
the polyamide comprising a —COOH/(—NH + —NH₂) molar ratio of from 1.07 to 1.11.

The polyamide can be prepared on the basis of a conventional process. For example, all of the reagents are charged to a suitable reactor equipped with a mixer and then heated under nitrogen at a temperature of between 190 to 250° C. for 20 to 500 min (until the volume of distillate no longer increases under nitrogen flushing). Then, the reactor is placed under vacuum at a pressure of between 5 ×10⁵ and 500 ×10⁵ mPa (5 and 500 mbar) and maintained under these conditions until the desired viscosity is obtained.

### Composition

In a second aspect, the present invention relates to a composition comprising a polyamide as defined above.

The polyamide composition can comprise, besides the polyamide obtained by polycondensation of the acid component and of the amine component, at least one additive.

The additive can be chosen from fillers, antioxidants or stabilizers, mold-release agents, adhesion promoters, pigments and their mixtures.

The adhesive composition may comprise from 0 to 5%, preferentially from 0.5 to 5%, of additives, relative to the weight of the polyamide.

In one embodiment, the polyamide composition is free of tackifying resins. The polyamide composition can have a viscosity of 10 000 mPa.s or less; preferentially from 3000 to 6000 mPa.s, at a temperature of 150° C. The viscosity is measured according to Standard ASTM D3236, using Brookfield equipment and an SC4-A27 spindle.

The polyamide composition may comprise a softening point (softening temperature) of 150° C. or less; preferentially from 100 to 145° C.; very preferentially from 115 to 140° C. The softening point can be measured according to Standard ASTM D3461, using “Cup&Ball” equipment and a temperature gradient of 2° C./min.

The polyamide composition may also comprise a tensile strength of 1.5 to 3.1 MPa. The tensile strength can be measured according to Standard ISO 527 by preparing test specimens of 1A type and by tensioning these test specimens using a dynamometer, at a rate of 50 mm/min.

The polyamide composition may also comprise an elongation at break of 70 to 170%. The elongation at break can be measured according to Standard ISO 527 by preparing test specimens of 1A type and by tensioning these test specimens using a dynamometer, at a rate of 50 mm/min.

The polyamide composition may also comprise a Shore A hardness of 60 to 80. The Shore A hardness can be measured according to Standard ISO 868, by using a durometer with recording of values immediately and after 15 sec. The polyamide composition may also comprise a Shore D hardness of 15 to 30%. The Shore D hardness can be measured according to Standard ISO 868, by using a durometer with recording of values immediately and after 15 sec.

### Molded Article

In a third aspect, the present invention relates to a molded article comprising an insert and the polyamide composition described above, said insert being overmolded at least in part by the polyamide composition. Said insert can be a battery, preferentially a heat-sensitive battery, very preferentially a lithium-polymer battery.

The molded article can additionally comprise a substrate. The substrate can be obtained from materials chosen from plastic, metal, glass, ceramic or any other appropriate substance, preferentially plastic; very preferentially, the plastic is a thermoplastic polymer. For example, the thermoplastic polymer can be acrylonitrile-butadiene-styrene (ABS).

In one embodiment, the polyamide composition can be injected between the insert and the substrate, in order to ensure the adhesion of the two parts together. In this configuration, the substrate forms the exterior casing of the molded article. In another embodiment, the polyamide composition can be injected around the insert, and the substrate, if present. In this configuration, the overmolded polyamide composition forms the exterior casing of the molded article. Any alternative configuration can be envisaged.

The insert, around which the polyamide composition is overmolded, can be any suitable insert, in particular a battery, in particular a rechargeable battery, for example the batteries used in electronic devices such as telephones and laptops. In one preferred embodiment, the insert is a polymer-lithium battery. The molded article can be obtained from any suitable molding process, for example by extrusion, cast molding, injection molding, compression molding or transfer molding. In one preferred embodiment, the molded article is obtained by a process by low-temperature and low-pressure injection, such as described below.

Process for the production of a molded article:

In a third aspect, the present invention relates to a process for producing a molded article.

The process by low-temperature and low-pressure injection can comprise the following steps:
providing a mold;
inserting the parts to be adhesively bonded (insert) into the mold, preferentially a lithium-polymer battery;
heating the polyamide composition to a temperature of 150° C. or less, preferentially from 120° C. to 150° C., in order to obtain a molten polyamide composition;
injecting the molten polyamide composition at a pressure of from 0.5 × 10⁵ to 50 ×10⁵ Pa, preferentially from 2 × 10⁵ to 40 × 10⁵ Pa;
cooling the injected polyamide composition;
optionally removing the obtained molded article from the mold.

Depending on the configuration, the mold can form an integral part of the molded article (for example if the polyamide composition is injected between the insert and the substrate) or can be removed after the overmolding of the polyamide composition.

The use of the polyamide composition for obtaining molded articles is particularly advantageous in that it can be molded at low pressure, in that it exhibits satisfactory flow properties at molding temperatures of 150° C. or less and in that it exhibits a satisfactory temperature strength in the molded state. These properties are suitable for the molding of electronic devices which are sensitive to high temperatures and which generate heat, in particular lithium-polymer batteries.

### Use

In a fourth aspect, the present invention relates to the use of the polyamide, or of the polyamide composition comprising same, as described above, as a hot-melt adhesive for the low-pressure overmolding of a heat-sensitive battery, preferentially a lithium-polymer battery, and optionally its substrate.

### EXAMPLE

The following example illustrates the invention without limiting it.

### Materials Used

Fatty acid dimer: Radiacid 0970® (fatty acid dimer, refined, high purity) from Oleon;
Fatty monoacid: Radiacid 0944® (fatty monoacid) from Oleon;
Fatty diacid 1: sebacic acid;
Fatty diacid 2: dodecanedioic acid;
Fatty diacid 3: azelaic acid;
Aliphatic diamine: ethylenediamine;
Cyclic diamine: piperazine;
Polyetheramine: Jeffamine D2000® (polyoxypropylenediamine) from Huntsman;
Fillers: liquid dye based on carbon black (2.5 - 10%);
Mold-release agent: Ethylene bis-Stearamide.

### Process for the Preparation of the Polyamide

All of the reactants are charged in a suitable mixer-equipped reactor and then heated under nitrogen for 4 h 30 up to a temperature of 225° C. Subsequently, the reactor is maintained at this temperature for 2 h 30 and then placed under vacuum at a pressure of between 1000 and 5000 Pa for 1 h.

### Polyamide

| | P1 | P2 | P3 | P4 |
|---|---|---|---|---|
| Acid component (mol%) | | | | |
| Fatty acid dimers | 43 | 43 | 43 | 41 |
| Fatty diacid 1 | 44 | 54 | - | 28 |
| Fatty diacid 2 | 10 | - | - | 28 |
| Fatty diacid 3 | - | - | 54 | - |
| Fatty monoacid | 3 | 3 | 3 | 3 |
| Amine component (mol%) | | | | |
| Aliphatic diamine (mol%) | 21 | 22 | 21 | 21 |
| Cycloaliphatic diamine | 74 | 74 | 74 | 74 |
| Polyetheramine | 5 | 5 | 5 | 5 |

### Polyamide Composition

| Compositions | 1 | 2 | 3 | 4 |
|---|---|---|---|---|
| Polyamide | P1 | P2 | P3 | P4 |
| Charge (% by mass) | 1 | 1 | 1 | 1 |
| Mold-release agent (% by mass) | 1 | 1 | 1 | 1 |
| Ratio acid (COOH):amine (primary and/or secondary) end groups | 1.09 | 1.09 | 1.09 | 1.09 |
| End group | Acid | Acid | Acid | Acid |

The mass percentage of filler and of molding agent is expressed as a function of the mass of polyamide.

### Results

| | | | | |
|---|---|---|---|---|
| Compositions | 1 | 2 | 3 | 4 |
| Viscosity (150° C.) (mPa.s) | 5820 | 5970 | 5260 | 6450 |
| Softening point (°C) | 121 | 126 | 138 | 119 |
| Tensile strength (MPa) | 2.4 | 2.9 | 1.7 | 2.7 |
| Elongation at break (%) | 118 | 88 | 96 | 155 |
| Shore A hardness | 74 | 78 | 64 | 78 |
| Shore D hardness | 16 | 18 | 11 | 17 |

Compositions 1 to 4, respectively comprising the polyamides P1 to P4, have a viscosity and a softening point which are particularly suitable for their use as hot-melt adhesive in processes for the overmolding of heat-sensitive inserts, in particular lithium-polymer batteries, and make it possible to obtain molded articles with satisfactory mechanical and thermal properties.

1-15. (canceled)

16. A polyamide which is the product of polycondensation of an acid component and of an amine component,
the acid component comprising, per mole of acid component:
from 25 to 50 mol% of at least one fatty acid dimer;
from 46 to 70 mol% of at least one aliphatic diacid; and
from 0 to 11 mol% of at least one chain limiter;
the amine component comprising, per mole of amine component:
from 13 to 29 mol% of at least one aliphatic diamine;
from 66 to 82 mol% of at least one cycloaliphatic diamine; and
from 0 to 15 mol% of at least one polyetheramine;
the polyamide comprising a —COOH/(—NH and/or —NH₂) molar ratio of from 1.00 to 1.20.

17. The polyamide as claimed in claim 16, wherein the fatty acid dimer is a product of a reaction for coupling unsaturated monocarboxylic acids.

18. The polyamide as claimed in claim 16, wherein the aliphatic diacid is selected from the group consisting of saturated aliphatic dicarboxylic acids.

19. The polyamide as claimed in claim 16, wherein the chain limiter comprises monocarboxylic acids, anhydrides, monohalogenated acids, monoesters or monoisocyanates.

20. The polyamide as claimed in claim 16, wherein the aliphatic diamine comprises linear or branched, saturated aliphatic diamines.

21. The polyamide as claimed in claim 16, wherein the cycloaliphatic diamine is selected from the group consisting of bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), bis(p-aminocyclohexyl)methane (PACM), isopropylidenedi(cyclohexylamine) (PACP), isophoronediamine, piperazine, aminoethylpiperazine, norbornyl methane, cyclohexylmethane, dicyclohexylpropane, di(methylcyclohexyl), di(methylcyclohexyl) propane, 1,4-cyclohexanediamine, 4,4′-diamino-dicyclohexylmethane, piperazine, cyclohexane-bis-(methylamine), isophoronediamine (IPDA), dimethylpiperazine, dipiperidylpropane, norbornanediamine, and mixtures thereof.

22. The polyamide as claimed in claim 16, wherein the polyetheramine is selected from the group consisting of polyoxyalkylenediamines with a number-average molecular weight (Mn) ranging from 200 to 4000 g/mol.

23. The polyamide as claimed in claim 16, wherein the polyamide is a product of polycondensation of an acid component and of an amine component,
the acid component comprising, per mole of acid component:
from 35 to 50 mol% of at least one fatty acid dimer;
from 52 to 70 mol% of at least one aliphatic diacid; and
from 2 to 5 mol% of at least one chain limiter;
the amine component comprising, per mole of amine component:
from 19 to 23 mol% of at least one aliphatic diamine, which is ethylenediamine;
from 72 to 76 mol% of at least one cycloaliphatic diamine, which is piperazine; and
from 3 to 5 mol% of at least one polyetheramine, which is polyoxypropylenediamine;
the polyamide comprising a —COOH/(—NH and/or —NH₂) molar ratio of from 1.07 to 1.11.

24. A composition comprising the polyamide as defined in claim 16.

25. The composition as claimed in claim 24, comprising at least one additive selected from the group consisting of fillers, antioxidants or stabilizers, mold-release agents, adhesion promoters, pigments and mixtures thereof.

26. The composition as claimed in claim 24, wherein the polyamide composition has a viscosity of 10,000 mPa.s or less at a temperature of 150° C.

27. The composition as claimed in claim 24, wherein the polyamide composition has a softening point of 150° C. or less.

28. A molded article comprising an insert and the polyamide composition as claimed in claim 24, said insert being overmolded at least in part by the polyamide composition.

29. A process for producing a molded article, comprising the following steps:
providing a mold;
inserting an insert into the mold;
heating a polyamide composition to a temperature of 150° C. or less, in order to obtain a molten polyamide composition;
injecting the molten polyamide composition at a pressure of from 0.5 × 10⁵ to 50 × 10⁵ Pa;
cooling the injected polyamide composition;
optionally removing the obtained molded article from the mold.

30. A hot-melt adhesive for low-pressure overmolding of a heat-sensitive battery comprising the polyamide of claim 16.

31. The polyamide as claimed in claim 17, wherein the fatty acid dimer is a product of a reaction for coupling unsaturated monocarboxylic acids, wherein the unsaturated monocarboxylic acids are selected from the group consisting of unsaturated monocarboxylic acids comprising from 10 to 22 carbon atoms.

32. The polyamide as claimed in claim 18, wherein the aliphatic diacid is selected from the group consisting of succinic acid, glutaric acid, adipic acid, pimelic acid, suberic acid, azelaic acid, sebacic acid, undecanedioic acid, dodecanedioic acid, brassylic acid, tetradecanedioic acid, pentadecanedioic acid, thapsic acid, and mixtures thereof.

33. The polyamide as claimed in claim 19, wherein the chain limiter comprises a monocarboxylic acid.

34. The polyamide as claimed in claim 20, wherein the aliphatic diamine is selected from the group consisting of ethylenediamine, propanediamine, butanediamine, pentanediamine, hexanediamine, decanediamine and mixtures thereof.
